(19) United States
(12) Patent Application Publication
(10) Pub. No.: US 2022/0250247 A1
(43) Pub. Date: Aug. 11, 2022

(54) REMOTE CONTROLLED DEVICE, REMOTE CONTROL SYSTEM AND REMOTE CONTROL DEVICE

(71) Applicant: Preferred Networks, Inc., Tokyo-to (JP)

(72) Inventors: Hirochika ASAI, Tokyo-to (JP); Kota NABESHIMA, Tokyo-to (JP)

(21) Appl. No.: 17/733,949

(22) Filed: Apr. 29, 2022

Related U.S. Application Data
(63) Continuation of application No. PCT/JP2020/040293, filed on Oct. 27, 2020.

(30) Foreign Application Priority Data
Nov. 1, 2019 (JP) 2019-200241

(51) Int. Cl. B25J 9/16; H04Q 9/00; G06N 20/00; G05B 19/4155; G05D 1/02

(52) U.S. Cl. CPC B25J 9/1689; H04Q 9/00; G06N 20/00; G05B 2219/50391; B25J 9/1664; G05D 1/0212; H04Q 2209/50; G05B 19/4155

(57) ABSTRACT

A remote controlled device comprises one or more memories and one or more processors. The one or more processors are configured to, when an event relating to a task being executed by a remote control object occurs: transmit information on a subtask of the task, receive a command relating to the subtask, and execute the task based on the command.

### CROSS REFERENCE TO RELATED APPLICATION

This application is continuation application of International Application No. JP2020/040293, filed on Oct. 27, 2020, which claims priority to Japanese Patent Application No. 2019-200241, filed on Nov. 1, 2019, the entire contents of which are incorporated herein by reference.

### FIELD

This disclosure relates to a remote controlled device, remote control system and remote control device.

### BACKGROUND

A device which transmits a gesture or the like to a robot which performs remote communication as a remotely controlled robot is developed, but the robot is not assumed to autonomously perform work. Besides, as a robot which autonomously operates, a robot which asks a manipulator for assistance when the robot loses its way is known, and is excellent in executing a task which cannot be completely autonomously operated, but the manipulator has difficulty in controlling a plurality of robots. In contrast to this, there is a method of setting a manipulator who can cope with each request and making a plurality of manipulators control the robot.

However, there are a case where some of manipulators cannot perform the autonomous operation, a case where the autonomous operation is undesirable from the viewpoint of privacy protection, and a case where an effective operation of the robot using the result of the task is difficult. Further, since only the assistance by the remote control is performed but assistance data is not acquired nor held, learning data cannot be acquired, so that it is difficult to apply the robot to a completely autonomous operation.

### BRIEF DESCRIPTION OF DRAWINGS

FIG. 1 is a schematic diagram illustrating the outline of a remote control system according to one embodiment;

FIG. 2 is a block diagram of the remote control system according to one embodiment;

FIG. 3 is a flowchart illustrating processing of the remote control system according to one embodiment;

FIG. 4 is a view acquired by a remote controlled device according to one embodiment;

FIG. 5 is a view illustrating a recognition result by the remote controlled device according to one embodiment;

FIG. 6 is a view illustrating an indirect instruction of a remote control device according to one embodiment;

FIG. 7 is a view illustrating a user space where the remote controlled device according to one embodiment exists;

FIG. 8 is a view illustrating a movable range by interference of the remote controlled device according to one embodiment;

FIG. 9 is a view illustrating an indirect instruction of the remote control device according to one embodiment;

FIG. 10 is a view illustrating an indirect instruction of the remote control device according to one embodiment;

FIG. 11 is a view illustrating an example of an outputter according to one embodiment;

FIG. 12 and FIG. 13 are views illustrating implementation examples of a remote control system according to one embodiment;

FIG. 14 is a block diagram of a remote control system according to one embodiment;

FIG. 15 is a flowchart illustrating processing of the remote control system according to one embodiment;

FIG. 16 to FIG. 18 are diagrams illustrating implementation examples of the remote control system according to one embodiment; and

FIG. 19 is a diagram illustrating a hardware implementation example of devices of the remote control system according to one embodiment.

### DETAILED DESCRIPTION

According to one embodiment, a remote controlled device comprises one or more memories and one or more processors. The one or more processors are configured to, when an event relating to a task being executed by a remote control object occurs: transmit information on a subtask of the task, receive a command relating to the subtask, and execute the task based on the command.

Hereinafter, embodiments of the present invention will be explained with reference to the drawings. The explanation of the drawings and embodiments is made as an example and does not limit the present invention.

First, the whole of a remote control system 1 in this disclosure will be explained.

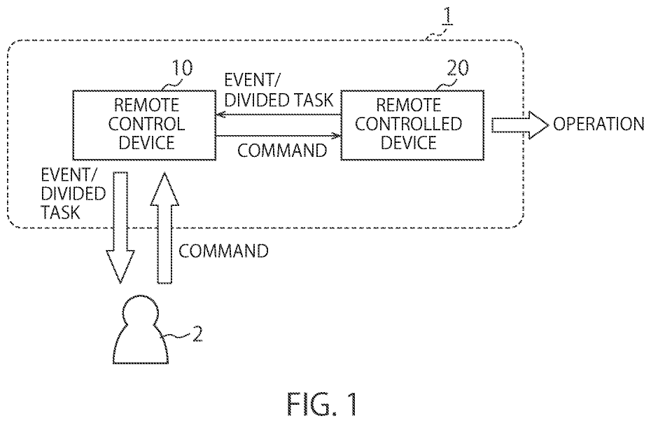

FIG. 1 is a schematic diagram illustrating the outline of the remote control system 1 according to one embodiment. The remote control system 1 in this embodiment includes at least a remote control device 10 and a remote controlled device 20, in which the remote control device 10 supports the operation of the remote controlled device 20. At least one of the remote control device 10 and the remote controlled device 20 may be a remote control support device.

The remote control device 10 (control device) is given a command or the like, for example, by a manipulator 2 using various user interfaces. This command is transmitted from the remote control device 10 to the remote controlled device 20 via a communication interface or the like. The remote control device 10 is, for example, a computer, a remote controller, or a mobile terminal (smartphone, tablet or the like). Further, the remote control device 10 may include a display, a speaker, or the like as an output user interface to the manipulator 2, and may include a mouse, a keyboard, various buttons, a microphone or the like as an input user interface from the manipulator 2.

The remote controlled device 20 (controlled device) is a device which accepts control by the remote control device 10. For example, the remote controlled device 20 produces an output on an end user side. The remote controlled device 20 includes, for example, a remote control object such as a robot or a drone. The robot (remote control object) here is a device which autonomously or semiautonomously performs an operation and includes, for example, an industrial robot, a vacuum-cleaning robot, an android, a pet robot, or the like and further includes a monitoring device, a managing device in an unmanned store, an automatic conveying device or the like, and may include a virtual control object in a virtual space. Hereinafter, the remote controlled device 20 is explained as a robot as an example for easy explanation, but can be read as an arbitrary remote control object as above.

Note that the entire remote controlled device 20 is included in, but not limited to, the remote control system 1 in FIG. 1. For example, an interface of a gripper, an end effector or the like which physically executes an operation on the end user side does not need to be included in the remote control system 1. In this case, the other portion of the remote controlled device 20 included in the remote control system 1 may be configured to control the interface of the remote controlled device 20 not included in the remote control system 1. The manipulator 2 may be a human, but may be a trained model or the like capable of making an instruction for appropriately solving a problem occurring in the remote controlled device 20 and having a performance higher than that of the remote controlled device 20 for a subtask (for example, object recognition or designation of a gripper) that is a problem. This can lighten, for example, a trained model included in the remote controlled device 20. It is also possible to decrease the performance of, for example, a sensor (resolution of a camera or the like).

The remote control system 1 performs, for example, the remote control as follows. First, the remote controlled device 20 autonomously or semiautonomously operates based on a predetermined task or a task decided based on the surrounding environment.

Upon detection of a state (hereinafter, referred to as an event) where the execution of the task is difficult during the autonomous operation, the remote controlled device 20 suspends the execution of the task for instance. Note that as a response after the detection, the remote controlled device 20 may execute a predetermined operation such as to preferentially execute, for example, an operation of securing the safety, an operation of avoiding a failure, another executable task in addition to the suspension of the execution of the task. Further, the remote controlled device 20 may record the fact that it processes the event, and then continue the execution of the task. This record may be managed by a list. Further, in the case where the execution of the task becomes difficult, after the same operation is tried a plurality of times and failed, the remote controlled device 20 may detect the failure as an event to be reported to the remote control device 10.

The remote controlled device 20 analyzes the task in which the event occurs, divides the task, and extracts a plurality of divided tasks relating to the occurred event. In this description, the division of the task includes the extraction of a portion of the task. Further, the generation of the task includes the extraction of the task.

Note that the task may be a set of subtasks each of which is a task in a unit smaller than that of the task. In this case, the remote controlled device 20 may analyze the task in which the event occurs without dividing the task, and extract a subtask relating to the event from among the plurality of subtasks constituting the task. In the case where the task is defined as a set of subtasks, namely, in the explanation of all of embodiments, the divided task may be read as the subtask. In the case where the task is defined by the subtasks, the division of the task is not necessary but may be arbitrarily executable.

As explained above, the divided task and the subtask may be regarded as almost equivalents in a broad sense. For example, in the case where the task is described in software, each of a module, a function, a class, a method and the like or an arbitrary connection of them may be a subtask. Further, the division of the task may be executed down to an arbitrary granularity such as the above module or the like. Further, the subtask may be analyzed and regarded as the divided task.

After the division of the task, for example, a score of reliability or the like of each of a plurality of divided tasks may be calculated for the divided tasks. Based on the score, the remote controlled device 20 may extract which divided task has caused the event.

The remote controlled device 20 transmits information on the extracted divided task to the remote control device 10. Besides, for example, in the case where the division of the task is difficult, the remote controlled device 20 may transmit information on the event to the remote control device 10.

The remote control device 10 outputs the event or the divided task to the manipulator 2 via the output user interface, and shifts to a standby state of waiting for a command.

When the manipulator 2 inputs a command into the remote control device 10 via the input user interface, the remote control device 10 outputs the command to the remote controlled device 20, which resumes the suspended task based on the command.

The command includes at least one of a direct instruction being a command of directly controlling a physical operation of the interface of the remote controlled device 20, and an indirect instruction for causing the remote controlled device 20 to make a determination based on the command and control the interface.

The direct instruction is for directly instructing the physical operation of the interface of the remote controlled device 20 as explained above. For example, in the case where the remote controlled device 20 includes the interface of performing a grip operation, the direct instruction is for instructing the interface to execute the grip operation after the end effector of the remote controlled device 20 is operated by a cursor key or a controller to a position where the end effector can grip a target.

The indirect instruction is for indirectly instructing the operation of the remote controlled device 20 as explained above. For example, in the case where the remote controlled device 20 includes the interface of performing a grip operation, the indirect instruction is an instruction of designating a grip position of a target but not directly instructing the physical operation of the interface of the remote controlled device 20. The remote controlled device 20 executes the operation of automatically moving the end effector without the operation by the manipulator 2 based on the designated grip position and automatically gripping the target.

For example, it is assumed that there is a task of placing a target on the floor onto a desk in the end user environment where the remote controlled device 20 exists. Such a case is considered that a robot equipped with an arm capable of gripping the target tried to execute this task but failed, thus causing an event, and the manipulator 2 executes the task using the remote control device 10.

For the direct instruction, for example, the manipulator 2 first moves the robot to a position where the robot can pick up the target using a controller or the like while viewing video of a camera. The movement is made by the manipulator 2 who determines how much and in which direction to advance the robot by pressing buttons for eight directions provided at the controller, and how long and which button to accordingly press. Upon determination that the robot has moved to the position where the robot can pick up the target, the manipulator 2 moves the arm to a position where the arm can grip the target. This movement is also directly executed by the manipulator 2 by using, for example, the controller equipped with the buttons capable of designating directions as with the movement of the robot. Then, upon determination that the arm has moved to the position where the arm can grip the target, the manipulator 2 executes an operation that the end effector provided at the arm grips the target. Subsequently, the manipulator 2 moves the robot by the same operation as the above to the position of the desk, moves the arm as above to the position where the manipulator 2 wants to place the target, and releases the gripping by the end effector, thereby placing the target on the desk. The gripping and the release of the gripping are also directly executed by the manipulator 2 by using, for example, the controller equipped with the buttons capable of designating the directions as with the other operation of the robot. As explained above, the direct instruction means that the manipulator 2 directly instructs the operation itself performed by the remote controlled device 20, by using the pad, the controller or the like.

Note that any of the movement of the robot, the movement of the arm, the gripping of the target, and the release of the gripping of the target which are subtasks constituting the task is performed by the direct instruction in the above example, but, for example, some of the subtasks can also be performed by the direct instructions.

On the other hand, for the indirect instruction, for example, the manipulator 2 designates the position of the target in an image taken by the camera. The robot autonomously moves according to the designation to the position where the arm reaches the designated target, and controls the arm to grip the target. Subsequently, the manipulator 2 designates the position where the target is to be placed. The robot autonomously moves according to the instruction to the position where the robot can place the target at the designated position, and places the target at the designated position. As explained above, the indirect instruction means the instruction that the manipulator 2 does not directly designate the operation but the remote controlled device 20 can semiautonomously operate based on the instruction.

Note that any of the movement of the robot, the movement of the arm, the gripping of the target, and the release of the gripping of the target which are subtasks constituting the task is performed by the indirect instruction in the above example, but, for example, some of the subtasks can also be performed by the indirect instructions. More various examples of the indirect instruction will be explained later.

The remote control system 1 is a system performing a semiautomatic operation which accepts an operation instruction of the manipulator 2 via the remote control device 10 with the occurrence of an event as a trigger in the case where the remote controlled device 20 is in operation as explained above.

Hereinafter, some aspects of the above remote control system 1 will be explained.

### First Embodiment

This embodiment illustrates one aspect of the above remote control system 1.

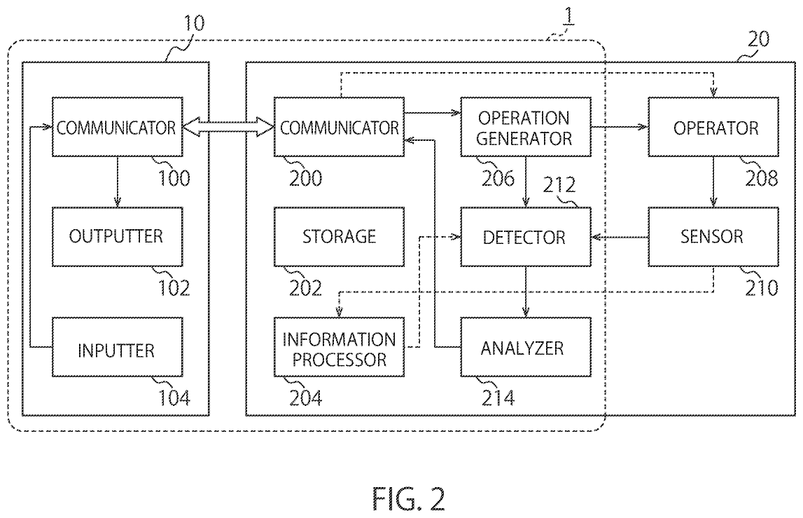

FIG. 2 illustrates an example of a block diagram of the remote control system 1 according to one embodiment. The remote control device 10 in this embodiment includes a communicator 100, an outputter 102, and an inputter 104. In addition, at least one of an information processor which performs information processing on input/output data and a storage which stores necessary data or the like may be provided. The remote controlled device 20 in this embodiment includes a communicator 200, a storage 201, an information processor 204, an operation generator 206, an operator 208, a sensor 210, a detector 212, and an analyzer 214.

The remote control device 10 receives an occurred event or a subtask (divided task) generated by division based on the event, from the remote controlled device 20 via the communicator 100.

The outputter 102 outputs the received event or divided task to the manipulator. The outputter 102 includes, for example, a display as an output user interface, and causes the display to display the received event or divided task. The output user interface included in the outputter 102 is not limited to the display, but may notify the manipulator of the state of the remote controlled device 20, for example, by outputting voice from a speaker or by causing a light emitting element such as an LED (Light Emitting Diode) to emit light.

The inputter 104 accepts input from the manipulator. The manipulator gives, for example, a direct instruction from the inputter 104 based on the event output to the outputter 102. As another example, the manipulator gives an indirect instruction from the inputter 104 based on the divided task output to the outputter 102.

When the manipulator inputs a command of the direct instruction or the indirect instruction, the communicator 100 transmits the command to the remote controlled device 20 via the communication interface.

The remote controlled device 20 is a device which autonomously or semiautonomously performs an operation.

The communicator 200 receives at least information transmitted from the remote control device 10.

The storage 202 stores data necessary for the operation of the remote controlled device 20, a program necessary for information processing, data transmitted/received by the communicator 200, and so on.

The information processor 204 executes information processing required for configurations included in the remote controlled device 20. The information processor 204 may include a trained machine learning model, for example, a neural network model. For example, recognition may be performed by inputting the information detected by the sensor 210 into the trained model. The neural network may include, for example, MLP (Multi-Layer Perceptron) or CNN (Convolutional Neural Network), may be formed based on a recurrent neural network and, not limited to them, may be an appropriate neural network model.

The operation generator 206 generates an operation necessary for the execution of the task in autonomous operation. Further, when the communicator 200 receives the indirect instruction from the remote control device 10, the operation generator 206 generates an operation relating to the event or the divided task based on the indirect instruction. Further, the operation generator 206 generates or acquires a control signal for performing the generated operation. In any of the cases, the operation generator 206 outputs the control signal for performing the generated operation to the operator 208.

The operator 208 includes a user interface on the end user side of the remote controlled device 20. For example, when the remote controlled device 20 is a robot, the operator 208 is a physical mechanism for the robot to perform an operation, such as an arm, a gripper, a moving device or the like of the robot. The operator 208 receives the control signal generated by the operation generator 206 as indicated by a solid line, or receives the control signal for executing the direct instruction input into the remote control device 10 via the communicator 200 as indicated by a broken line, and performs an actual operation in the end user environment.

The sensor 210 detects the surrounding environment of the remote controlled device 20. The sensor 210 may include, for example, a camera, a contact sensor, a weight sensor, a microphone, a temperature sensor, a humidity sensor and so on. The camera may be an ordinary RGB camera, or an RGB-D camera, an infrared camera, a laser camera or the like.

The detector 212 detects an event. The detector 212 detects the event based on the information from the operation generator 206 or the sensor 210. The event is information that gripping is failed when the remote controlled device includes a gripper or that gripping is difficult because the recognition degree in the image acquired by the sensor 210 is insufficient.

When the detector 212 detects the occurrence of the event, the analyzer 214 analyzes the task under execution based on the event and, and when determining that it is possible to divide the task, divides the task under execution to generate the divided task relating to the event. The information on the divided task is output to the communicator 200, and transmitted by the communicator 200 to the remote control device 10. The determination whether it is possible to divide the task and the generation of the divided task relating to the event or the extraction of the subtask may be performed by arbitrary methods. For example, they may be performed on a rule basis or may be performed by a trained model.

The remote control system 1 may include, for example, the communicators 100, 200, the outputter 102, the inputter 104, the storage 202, the information processor 204, the operation generator 206, the detector 212, and the analyzer 214 of the above configurations. The remote control system 1 may have another aspect, and may also include, for example, the operator 208 and the sensor 210. Besides, the components of the remote controlled device 20 may be provided in the remote control device 10 or another device such as a server as long as they can perform appropriate processing.

The remote controlled device 20 is composed of one device, or may be composed of two or more devices, and, for example, the sensor 210 may be a camera provided to monitor a space on the end user side. As another example, the storage 202 and the information processor 204 may be provided as another computer different from the robot, in the environment on the end user side, and transmit a wireless or wired signal to the robot or the like to control the robot or the like.

As explained above, the configurations of the remote control device 10 and the remote controlled device 20, and the configurations of the components of the remote control system 1 can be arbitrarily modified. In the case where at least one of the remote control device 10 and the remote controlled device 20 is composed of a plurality of devices, communicators which perform communication between the devices may be provided in the respective devices.

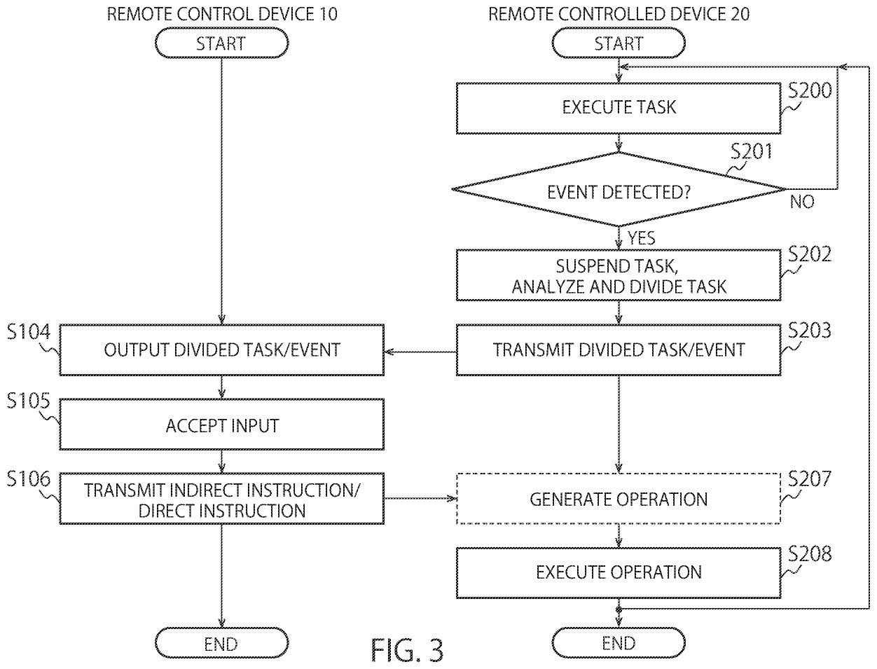

FIG. 3 is a flowchart illustrating an operation example of the remote control system 1 according to this embodiment. As explained above, the configurations of the remote control device 10 and the remote controlled device 20 can be appropriately reconstructed, but this flowchart illustrates the operation based on the configurations in FIG. 2.

It is assumed that the remote controlled device 20 is executing the task set by the autonomous operation (S200). For example, in the initial state, the remote controlled device 20 itself may detect the environment by the sensor and execute the task, or may receive a command to execute the task from the remote control device 10.

When the detector 212 does not detect the event (S201: NO), the remote controlled device 20 continues the execution of the task (S200).

When the detector 212 detects the event (S201: YES), the remote controlled device 20 suspends the execution of the operation of the operator 208, that is, the task in this embodiment, and the analyzer 214 analyzes the occurred event (S202). When the task can be cut out regarding the occurred event as a result of the analysis, the analyzer 214 divides the task to generate and acquire a divided task.

Next, the remote controlled device 20 transmits the divided task or the event to the remote control device 10 via the communicator 200. For example, the remote controlled device 20 transmits the divided task when the division of the task is possible at S202, and transmits the event when it is determined that the division of the task is impossible, difficult, or unnecessary (S203).

Next, upon reception of the divided task or the event transmitted from the remote controlled device 20 via the communicator 100, the remote control device 10 outputs the received divided task or event to the manipulator (S104).

Next, after outputting the divided task or the event, the remote control device 10 shifts to a standby state of accepting input of a command from the manipulator via the inputter 104 (S105). Note that the standby state for the input is not after the output, but the remote control device 10 may be in the standby state for the input in a normal state.

Upon acceptance of an indirect instruction for the output divided task or a direct instruction for the output event from the manipulator, the remote control device 10 transmits the indirect instruction or the direct instruction to the remote controlled device 20 via the communicator 100 (S106).

When the command received by the communicator 200 is the indirect instruction, the operation generator 206 generates an operation based on the received indirect instruction (S207). Then, the operation generator 206 transmits a control signal based on the generated operation to the operator 208, and performs control the operator 208 to execute the task (S208).

On the other hand, when the command received by the communicator 200 is the direct instruction, the remote controlled device 20 outputs the direct instruction to the operator 208, and performs control the operator 208 to execute the task (S208). Note that when the direct instruction is not output as a direct control signal, the information processor 204 may convert the direct instruction into a signal of controlling the operation of the operator 208, and output the control signal to the operator 208.

In the case where the execution of the task has not been ended or in the case where the execution of the task has been ended but a new task exists, the remote controlled device 20 continuously performs the steps from S200. In the case where the execution of the task has been ended and the operation is ended, the remote controlled device 20 ends the processing.

As explained above, according to this embodiment, when an event is detected in a task under execution, it is possible to support that the remote controlled device 20 executes the task, by the indirect instruction based on the divided task obtained by dividing the task. The remote control by the direct instruction may differ in result depending on the level of learning of the manipulator, and it is considerable that there is a task which requires a long time for learning. However, the instruction of the operation of the remote controlled device 20 by the method as in this embodiment can reduce the influence by the level of learning and obtain an appropriate result by any manipulator. Further, there is a case where even a skilled manipulator has difficulty in controlling the remote controlled device 20 due to a communication delay or a delay or the like of the signal processing in the remote controlled device 20. In such a case, it is possible to execute the task by the indirect instruction.

Here, some concrete examples of the contents of the processing at each step will be illustrated. Hereinafter, some examples of the event for a task of gripping an object will be explained.

The event is detected in the following case. For example, in the case where the remote controlled device 20 includes an end effector which executes gripping, when the end effector was not able to catch a target to be gripped or fell the gripped target, such an event that the end effector was not able to catch or fell the target is detected by sensing by a weight sensor, a tactile sensor or the like, or the like provided at the end effector, sensing by a camera, or detection of a movement of a grip portion of the end effector or the like.

Further, for example, in the case where the remote controlled device 20 further includes a camera as the sensor 210 and the information processor 204 performs recognition processing on the image taken by the camera to decide a grip position or the like based on the recognition result, when the accuracy or reliability of the recognition result is low (for example, when a recognition result of accuracy or reliability of less than 50% is acquired), an event that the reliability of recognition is low is detected based on the output from the sensor 210. In this case, for example, the detector 212 may monitor the recognition result of the information processor 204 and generate the event when there is a target lower in recognition accuracy than a predetermined threshold value.

Besides, for example, in the case where the remote controlled device 20 is a robot which moves, and includes an end effector or the like which executes gripping, when a way to the target to be gripped cannot be automatically discriminated in the image acquired by the sensor 210, such an event that the way cannot be discriminated may be detected.

The events relating to the task of gripping the target are the above examples. The examples of the event are not limited to the above, but variously determined for the task to be executed.

For the above event, the analysis and division of the task are executed as follows. First, for example, when the remote controlled device 20 has failed to grip the target, the failure of gripping is detected as an event, and the event is notified to the remote control device 10 without analyzing the task, and a direct instruction from the manipulator may be accepted.

Besides, for example, when an event that the remote controlled device 20 has difficulty in gripping the target because of low recognition accuracy is detected, the task is divided, whereby a task of executing recognition is acquired as a divided task. The acquired divided task may be notified to the remote control device 10 and an indirect instruction from the manipulator for the divided task capable of eliminating the event may be accepted. Examples of the indirect instruction from the manipulator in this case include notifying the remote control device 10 to increase the recognition rate of the target difficult to recognize, or notifying the remote control device 10 of the recognition result different that made by the remote controlled device 20. The remote controlled device 20 generates an operation by the operation generator 206 based on the indirect instruction received from the remote control device 10 and executes the grip operation.

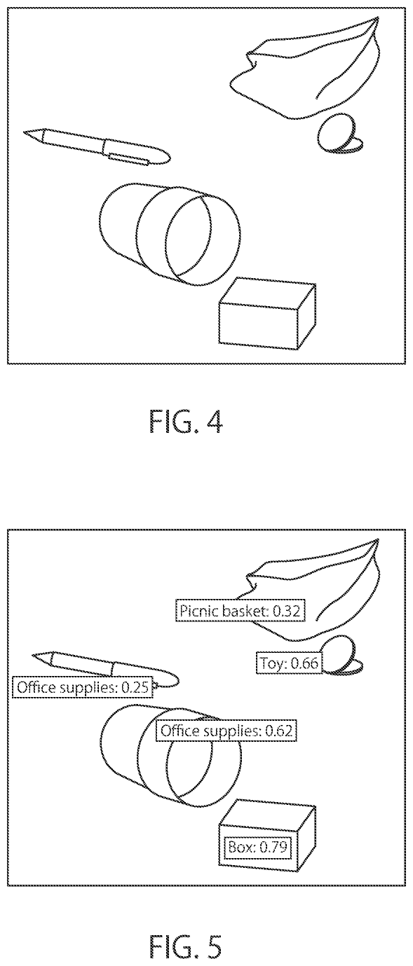

FIG. 4 indicates an image acquired by the remote controlled device 20 using the camera being the sensor 210 in one embodiment. Specifically, FIG. 4 is an image in which objects such as a box, office supplies, a toy and so on scattering on the floor. It is assumed that a task to be executed is clearing away the office supplies in the image.

FIG. 5 is a view indicating a recognition rate being a result recognized by the remote controlled device 20 of each object in the image of FIG. 4. The recognition rate is indicated by a numerical value between 0 and 1, and a numerical value closer to 1 indicates higher recognition accuracy. A penholder placed on the front side is recognized as the office supply with a recognition rate of 0.62 which is a relatively high recognition rate, and therefore the task is executable.

On the other hand, a pen placed on the back side is recognized as the office supply with a recognition rate of 0.25. Here, under a certain condition, for example, in the case where it is set that the task is executed when the threshold value exceed 0.5, the remote controlled device 20 determines that it is difficult to execute the task for the pen, and suspends the task. After the suspension, the analyzer 214 analyzes the task and extracts a task regarding the recognition of the task, as a divided task or a subtask. The remote controlled device 20 transmits the divided task relating to the recognition as the divided task that has been determined to be a cause of a problem, to the remote control device 10.

When the image of FIG. 5 is output in the remote control device 10, the manipulator inputs an indirect instruction that the pen in the image is an office supply, via the inputter 104. The remote control device 10 transmits the input indirect instruction to the remote controlled device 20. The remote controlled device 20 received the indirect instruction causes the operation generator 206 to resume the execution of the task based on the recognition result that the pen is the target.

As explained above, the task to be executed is suspended depending on the recognition result of the object, the operation of recognizing the object is cut out from the task or the operation to be executed based on the recognition is cut out, and the suspended task is resumed by the indirect instruction.

As another example, also in the case where the gripping has been failed in the same situation as that in FIG. 4, it is also possible to analyze the task and acquire the divided task. In other words, in the case where the gripping has been failed as above, the event is not immediately notified to the remote control device 10, but the task analysis is tried and, if the divided task can be acquired as a result, it is possible to require the indirect instruction from the manipulator.

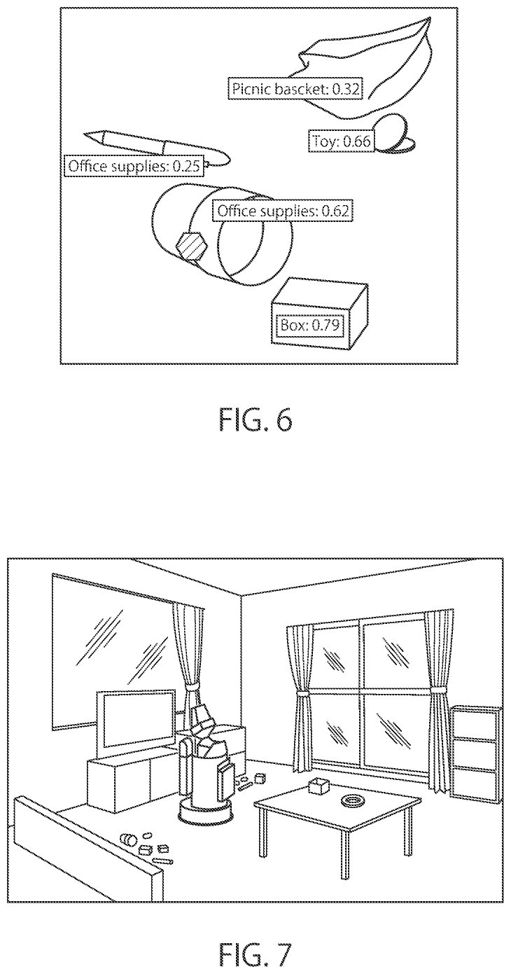

FIG. 6 is a view illustrating an example in which the indirect instruction is executed when the gripping has been failed. It is assumed that in the execution of the task of clearing away the office supplies, the gripping of the penholder recognized as the office supply has been failed. The failure of the gripping can be detected, for example, by a feedback sensor of a robot hand which executes the gripping. The detector 212 detects, for example, that the gripping has been failed based on the detection result of the sensor 210 which detects the state of the operator 208 as illustrated in FIG. 2.

When failing the gripping, the remote controlled device 20 suspends the task and divides the task of clearing away the office supplies into two divided tasks of object recognition and grip planning by the operation generator 206. Then, the remote controlled device 20 infers which of the divided tasks is the cause of the failure. For example, when the recognition result of the target is 0.62 that is sufficiently high as the office supply, the analyzer 214 determines that the task has been failed in the subtask of generating the operation by the operation generator 206. The analyzer 214 notifies the remote control device 10 of the grip planning based on the result and makes an output to the manipulator to issue an indirect instruction regarding the grip planning.

The manipulator indicates, for example, a grip position indicated by hatched lines in FIG. 6 as the indirect instruction. The indirect instruction regarding the grip position is transmitted to the remote controlled device 20, and the operation generator 206 generates, based on the transmitted information, a grip operation of the robot arm gripping the target at the designated grip position, and resumes the task.

FIG. 7 is a view of an appearance, acquired by the sensor, of the end user space where the remote controlled device 20 exists. For example, the remote controlled device 20 includes a robot, and a sensor 210 (camera) which acquires the state of the end user space as an image and is provide separately from the robot. In this case, it is also possible to acquire the state of the end user space not from the viewpoint from the robot but also in a bird's eye view.

The movement of the robot is assumed to be determined also in the image acquired by the sensor 210 (camera) provided on the ceiling or the like of the end user space in addition to the viewpoint from the robot, that is, the sensor provided at the robot such as a LiDAR, an odometer, or a torque sensor. In the case where the information processor 204 acquired the information from the sensor 210 processes the movable range of the robot, if making a mistake in the inference of the movable range, the robot can scarcely move in some cases. For example, in the state as in FIG. 7, almost the whole central space may be naturally considered as the movable range of the robot. However, a different result may be produced depending on the inference. As an event, an example of detecting that the movable range is limited and the robot cannot sufficiently approach the target to be gripped will be explained.

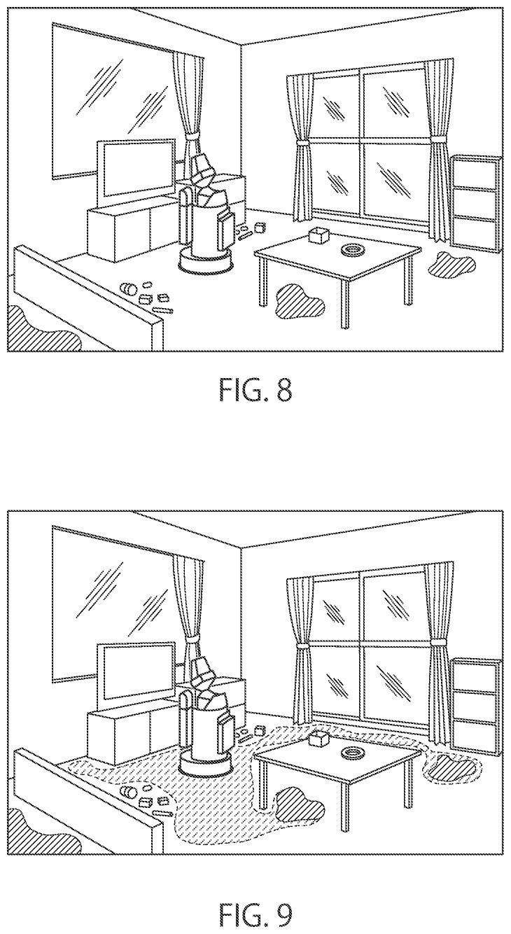

FIG. 8 is an example where a wrong movable range is designated by the information processor 204. For example, it is assumed that the remote controlled device 20 recognizes only shaded ares as the movable range as a result of the inference of the information processor 204 from the image. Note that the inference of the information processor 204 is not limited to the one from the image, but the information processor 204 may execute the inference based on outputs from various sensors. In this case, the remote controlled device 20 detects by the detector 212 that the robot cannot move and thus has a difficulty in executing the various tasks. Upon the detection, the execution of the task is suspended, and the analysis and division of the task are executed by the analyzer 214. The divided task is transmitted to the remote control device 10. For example, the divided task in this case is a divided task relating to the recognition of the region.

Note that in the case of acquiring an image, all of objects in the user space do not need to be output in detail on the remote control device 10 side. For example, information relating to the privacy of the user can exist in the user space. In this case, the information relating to the privacy of the user may be prevented from being transmitted to a remote manipulator. Specifically, control may be conducted in a manner to prevent the information relating to the privacy from being output from the remote control device 10 depending on the region based on the recognition result by the image recognition or the region designated using a maker or the like. The information relating to the privacy may be, for example, information such as a password, the number of a passbook or another ID associated with the user, a lavatory, a dressing room and so on. Further, not only the image but also voice may be cut off. For example, daily life noise and the like may be prevented from being output from the remote control device 10. Besides, a region made invisible may be determined, and the output data may be controlled so as to prevent the region determined to be invisible from being viewed.

FIG. 9 is a view illustrating an example of the indirect instruction. The analyzer 214 may correct the inference result by making the manipulator instruct the movable range, for example, because there is a wrong recognition of the image, and perform the operation generation. In this case, the manipulator may designate the movable range on the image as indicated, for example, by broken lines in the remote control device 10, and transmit an indirect instruction including the information relating to the movable range to the remote controlled device 20.

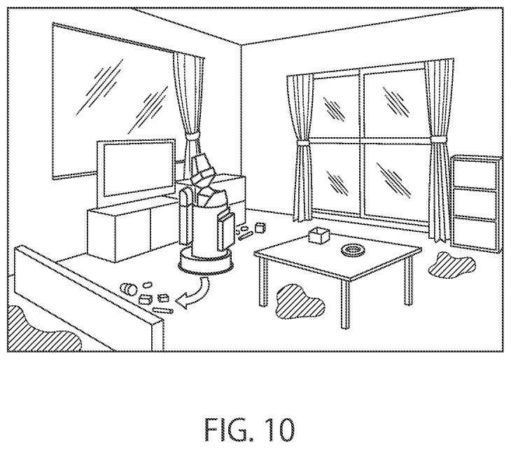

FIG. 10 is a view illustrating another example of the indirect instruction. The analyzer 214 may correct the inference result by making the manipulator instruct the position to which the robot moves, the moving route or the like, for example, because there is a wrong recognition, and perform the operation generation. In this case, the manipulator may designate, for example, the moving route on the image as indicated by an arrow in the remote control device 10, and transmit an indirect instruction including the information relating to the moving route to the remote controlled device 20.

In FIG. 9 and FIG. 10, it is not necessary for the remote controlled device 20 to transmit what indirect instruction is necessary. For example, the remote controlled device 20 may accept both of the input of the movable range as illustrated in FIG. 9 and the input of the moving route as illustrated in FIG. 10, for the divided task of moving. In other words, the method of instruction for solving the event, that is, whether to designate the movable range or designate the moving route in this example may be left to the manipulator.

Further, in the case where the divide task as illustrated in FIG. 8 is output, the manipulator may determine to solve the event not by the indirect instruction but by the direct instruction. In this case, the manipulator may transmit a signal for directly controlling the remote controlled device 20, via the controller or the like being the remote control device 10.

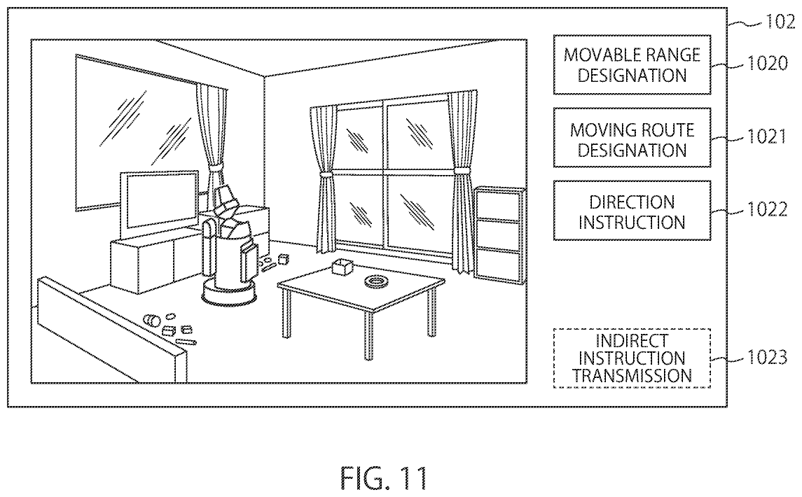

As explained above, when a plurality of divided tasks or the event is transmitted, the manipulator may be made to select which of the operations is to be performed in the remote control device 10. FIG. 11 is an example of outputting display of causing the manipulator to select issuing an indirect instruction or issuing a direct instruction for which of the divided tasks. As illustrated in FIG. 11, through the reception of information from the remote controlled device 20, the display as the outputter 102 provided in the remote control device 10 may enable selection of the operation being the object of the indirect instruction.

When designating the movable range, the manipulator selects, for example, a button 1020 to designate the movable range. In this case, a button 1023 for indirect instruction transmission may be separately displayed, and after the designation of the movable range, the indirect instruction may be transmitted to the remote controlled device 20, for example, by pressing the button 1023. Similarly, when designating the moving route, the manipulator selects a button 1021 to designate the moving rote.

Another example may be a form in which when the button 1020, 1021 or the like is pressed after the movable range, the moving route or the like is designated, the indirect instruction is transmitted.

When determining that it is difficult to give an indirect instruction to the robot, the manipulator may be able to switch to a direct instruction, for example, by pressing a button 1022 which selects a direct instruction. In this case, the manipulator transmits the direct instruction to the remote controlled device 20 via the remote control device 10. Further, a button for switching again to the indirect instruction after switching to the direct instruction may be displayed in a selectable state.

As another example, in the case where the interactive processing by remote control is difficult because of an extremely large delay of the network, the task may be divided and the interactive property may be closed on the user side.

For example, in the case where the task to be performed by the robot is a task of pressing a button, when the operation is performed in the network having a large communication delay, a delay occurs in the camera video. It is difficult for the manipulator to perform the operation of pressing the button while confirming the video. For example, when the manipulator performs the operation of pressing the button while watching the video, the control is delayed due to the delay and may cause a problem such as excessive pressing of the button. Further, the operation speed becomes low.

In this case, the analyzer 214 may divide the task into: a divided task causing less problem even if a delay occurs, for example, a task of moving the robot arm to a position where the robot arm easily presses the button or a task of recognizing a portion to be pressed of the button; and a divided task which may cause a problem if a delay occurs, for example, a task of pressing the button by a tip of the robot arm, and the manipulator may directly or indirectly instruct only the divided task causing less problem even if a delay occurs. In the above case, the manipulator may command recognition of the portion to be pressed of the button by the indirect instruction. Based on the indirect instructions, the remote controlled device 20 can move the robot arm and execute the task of pressing the button. This can alleviate the difficulty of the operation due to the delay of the network.

The task of automatically performing the grip operation by the robot capable of moving and gripping is illustrated in the above example, but the remote controlled device 20 and the task are not limited to the above. For example, the remote control system 1 can be used as a monitoring robot in the unmanned store or the like.

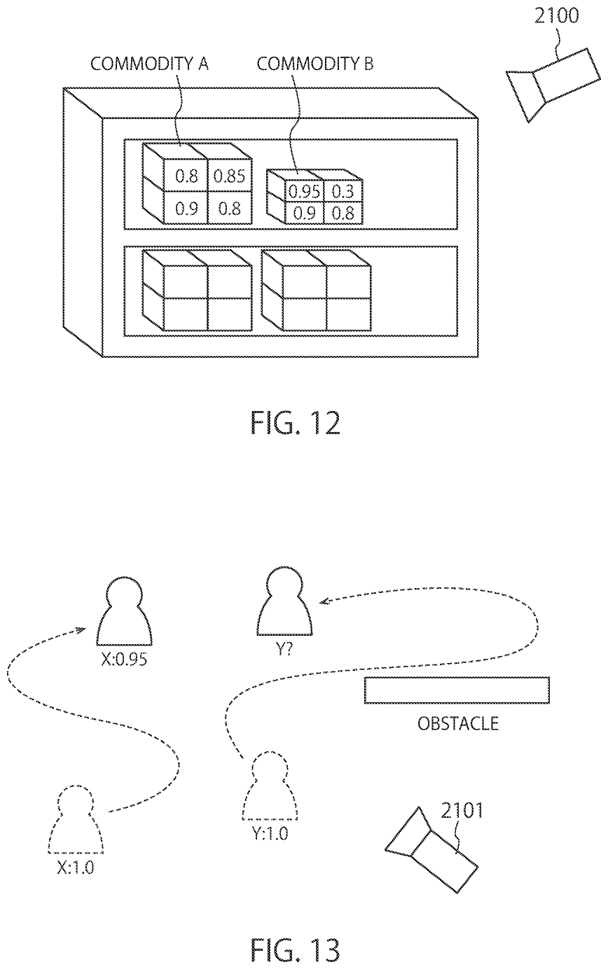

FIG. 12 is a view illustrating an example in which the remote control system 1 is applied to monitoring a store or unmanned buying and selling according to one embodiment. In this embodiment, the whole store including sensors and registers installed in the store (environment) is regarded as the remote controlled device 20. For example, a first camera 2100 provided on the ceiling of the store acquires the state of shelves on which commodities are placed. The information processor 204 performs processing of calculating the recognition degree of each of the commodities in the image taken by the first camera 2100, for example, as a dotted arrow illustrated in FIG. 2. The information processor 204 performs the processing, and the detector 212 detects the occurrence of an event in the result processed by the information processor 204. Upon detection of the event, the detector 212 outputs it to the analyzer 214.

The analyzer 214 confirms the recognition degrees of the commodities placed on the shelves. For example, in FIG. 12, commodities A have recognition degrees of 0.8, 0.85, 0.9, 0.8 which are relatively high values, so that commodities can be determined to be recognized without any problem.

On the other hand, a commodity on the upper right of commodities B has a recognition degree of 0.3 which is a low value, and is determined to be not appropriately recognized because the value is below a threshold value, for example, when the threshold value of the recognition degree is set to 0.5. In this case, the remote controlled device 20 may analyze and divide the task by the analyzer 214, and transmit the divided task relating to the recognition degree to the remote control device 10. The manipulator can give an indirect instruction about a problematic portion based on the information output from the outputter 102, for example, the image acquired by the first camera 2100. The remote controlled device 20 may resume the operation generation based on the indirect instruction.

In the state of FIG. 12, the recognition degree of the commodity on the upper right of the commodities B is low, so that the manipulator performs confirmation and transmits the fact that the commodity on the upper right is the commodity B to the remote controlled device 20 as an indirect instruction. The remote controlled device 20 recognizes that the commodity on the upper right is the commodity B and continues to take video. Note that in this case, only the task relating to the recognition may be suspended and the task of taking video is not suspended but may be continued.

As explained above, all of the tasks are not suspended, for example, only the task relating to the recognition which is suspected to cause a problem may be divided and transmitted to the remote control device 10 as in this embodiment.

As a system of performing segmentation of commodities in the store or the like, the remote control system 1 may be used. As a matter of course, an image relating not only to the commodity but also to a human who purchases the commodity may be acquired.

FIG. 13 is a view illustrating an example in which the remote control system 1 is applied to the tracking of a human according to one embodiment. A second camera 2101 takes, for example, an image of the space of the end user, and the remote controlled device 20 executes a task of tracking the human in the image taken by the second camera 2101. The information processor 204 executes the tracking of a person based on the information taken by the camera 2101.

In this case, it is possible to perform the tracking, without any problem, a person X who does not go around to the back side of an obstacle with respect to the second camera 2101. On the other hand, a person Y once hides in a blind spot of the second camera 2101 and then enters again an imaging range of the second camera 2101. In this case, the tracking of the person Y cannot sometimes be satisfactorily executed.

When the accuracy of tracking cannot be ensured, the information processor 204 notifies the analyzer 214 that the accuracy of tracking deteriorates. The analyzer 214 receiving the notification analyzes and divides the task and transmits the divided task relating to the recognition of the tracking to the remote control device 10. When the manipulator determines that an unclear person is Y, for example, from the past video or the like, the remote control device 10 transmits an indirect instruction of a command that the person is regarded as Y input by the manipulator to the remote controlled device 20. Upon reception of the indirect instruction, the remote controlled device 20 resumes or continues to track the person Y.

The tasks illustrated in FIG. 12 and FIG. 13 may be operated at the same timing. For example, in the case where the person Y once enters the blind spot and then holds the commodity B by a hand and tries to buy it, the remote control system 1 receives the fact that the person is the person Y through the indirect instruction from the remote control device 10, whereby the remote controlled device 20 may execute a buying and selling operation. The task of the buying and selling operation may be suspended until receiving the indirect instruction.

Conversely, when it is unclear that the commodity picked up by the person Y is the commodity B, the remote control device 10 may similarly transmit an indirect instruction about the commodity and the remote controlled device 20 may appropriately execute the task.

Furthermore, the remote control system 1 is also applicable to the case where the recognition of both of the person and the commodity is difficult. In the above example, when the person who was unable to be tracked is tried to purchase a commodity having a low recognition degree, the indirect instruction of the divided task relating to the person and the indirect instruction of the divided task relating to the commodity are transmitted from the remote control device 10, and the remote controlled device 20 may execute the tasks according to the indirect instructions.

In the above case, the cameras may be cameras which take images of separate regions, as the first camera 2100 and the second camera 2101. Further, the cameras may execute separate tasks, respectively. For example, the first camera 2100 may execute the task of recognizing the commodities on the shelves as explained above, and the second camera 2101 may execute the task of tracking the person as explained above. Further, separately from the tasks executed by the respective cameras, a task of automatically performing commodity purchase of a customer may be executed by using the images taken by the cameras 2100, 2101. As explained above, the remote control system 1 may include a plurality of sensors or operators and may operate using information from the plurality of sensors or operators. In this case, the remote control may be performed on an event or a task which generally increases in difficulty of processing and occurs due to use of the information from the plurality of sensors or operators. Further, the remote control system 1 may execute a plurality of tasks in parallel as separate tasks, and may execute tasks based on the execution of those tasks in parallel.

As explained above, the remote control system 1 according to this embodiment is applicable to various situations. Note that the above examples are illustrated as some examples only, the analysis and division of the event and the task are not limited to them, and the remote control system 1 is applicable to various aspects.

### Second Embodiment

For example, the indirect instruction is used for the execution of the task in real time in the above, but the remote control system 1 is not limited to this. The remote control system 1 may improve the execution accuracy of a subsequent task based on the indirect instruction given from the manipulator to smoothly execute the task. In the explanation and the drawings, the same codes are given to components which execute the same operations as those in the first embodiment for convenience.

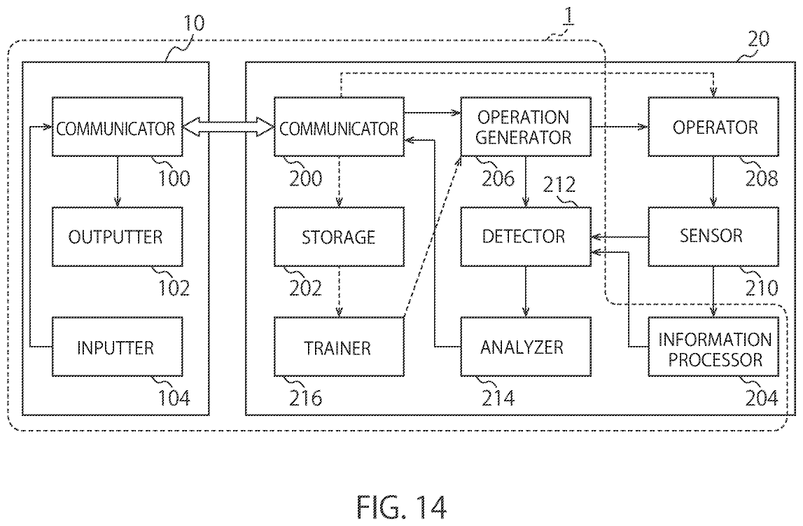

FIG. 14 is a block diagram of a remote control system 1 according to this embodiment. The remote control system 1 according to this embodiment includes a trainer 216 in addition to the remote control system 1 according to the above embodiment. The flow of data when receiving a command being an indirect instruction from the remote control device 10 is indicated by a dotted line.

When the remote control device 10 transmits the indirect instruction and the remote controlled device 20 receives the indirect instruction via the communicator 200, information relating to the received indirect instruction is stored in the storage 202. The information relating to the indirect instruction is, for example, information such as information for correcting the recognition result, information for correcting the movable range, or the like in the above-illustrated example. The storage 202 stores, for example, these kinds of information in association with information processing results by the information processor 204 or in association with at least part of information detected by the sensor.

The trainer 216 trains the trained model using a neural network which the information processor 204 uses, for example, for recognition based on the information relating to the indirect instruction stored in the storage 202. This training is executed, for example, by reinforcement learning. The parameters of the trained model may be trained not by the reinforcement learning but by the ordinary leaning method. As explained above, the trainer 216 improves the recognition accuracy using the information relating to the indirect instruction as teacher data.

The trainer 216 may execute retraining every time receiving the indirect instruction, or may perform the training upon detection of a state where computation resources can be sufficiently secured such as no execution of the task being executed. Besides, the trainer 216 may perform the training at such a frequency that it executes the training periodically, for example, at a predetermined time every day using a cron or the like. As another example, the trainer 216 may perform retraining when the number of pieces of information relating to the indirect instruction stored in the storage 202 becomes a predetermined number or more.

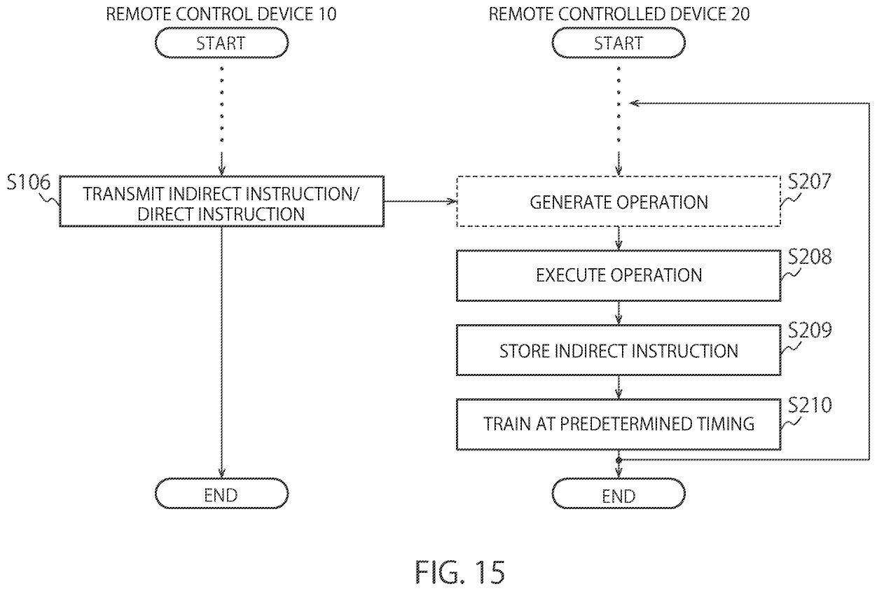

FIG. 15 is a flowchart illustrating the flow of processing according to this embodiment. The same processing as that in FIG. 3 is omitted.

After accepting the input by the manipulator, the remote control device 10 transmits the information on an indirect instruction or a direct instruction to the remote controlled device 20 (S106). When the received command is the indirect instruction, the remote controlled device 20 generates an operation for executing the task (S207). Then, the operator 208 executes the generated operation or the operation based on the direct instruction (S208).

Here, the remote controlled device 20 stores the information relating to the instruction in the storage 202 (S209).

The trainer 216 executes the training of the trained model used for recognition or the like based on predetermined timing, for example, the timing when receiving the indirect instruction as above (S210).

Note that in the flowchart in FIG. 15, the generation of the operation and the training are directly executed, but not limited to this. The training by the trainer 216 may be independent from the task executed by the remote control system 1. Therefore, the training may be executed in parallel with the operation. The parameters updated by the training are reflected in the trained model at the timing exerting no influence on the execution of the task.

As explained above, according to this embodiment, when the autonomous execution of the task in the remote controlled device 20 is difficult, the remote control system 1 receives an indirect instruction from the manipulator as in the above embodiment and can resume the execution of the task. Further, the remote control system 1 stores the data on the received indirect instruction or direct instruction as the teacher data and executes training using the data, thereby making it possible to improve the recognition accuracy and the like in the remote controlled device 20. As a result of this, for example, it is possible to suppress the occurrence of the same event again. It is also possible to suppress the probability that similar events occur. As explained above, the execution of the training based on the machine learning in the remote controlled device 20 enables the more accurate, more smooth and autonomous execution of the task.

Note that the trainer 216 is provided in the remote controlled device 20, but may be provided in another apparatus, for example, when the remote controlled device 20 exists in a network having sufficient communication volume and communication speed.

Further, when a plurality of remote controlled devices 20 exist and are communicable, the information on the direct instruction, indirect instruction, task or event given to one of the remote controlled devices 20 may be used for the training or the updating of the trained models provided in the other remote controlled devices 20.

Further, the storage 202 may hold the information obtained from the plurality of remote controlled devices 20, and the trainer may train the trained model using the information obtained from the plurality of remote controlled devices 20.

### Third Embodiment

In the above embodiments, the remote control system in which one remote controlled device 20 is connected to one remote control device 10 is explained.

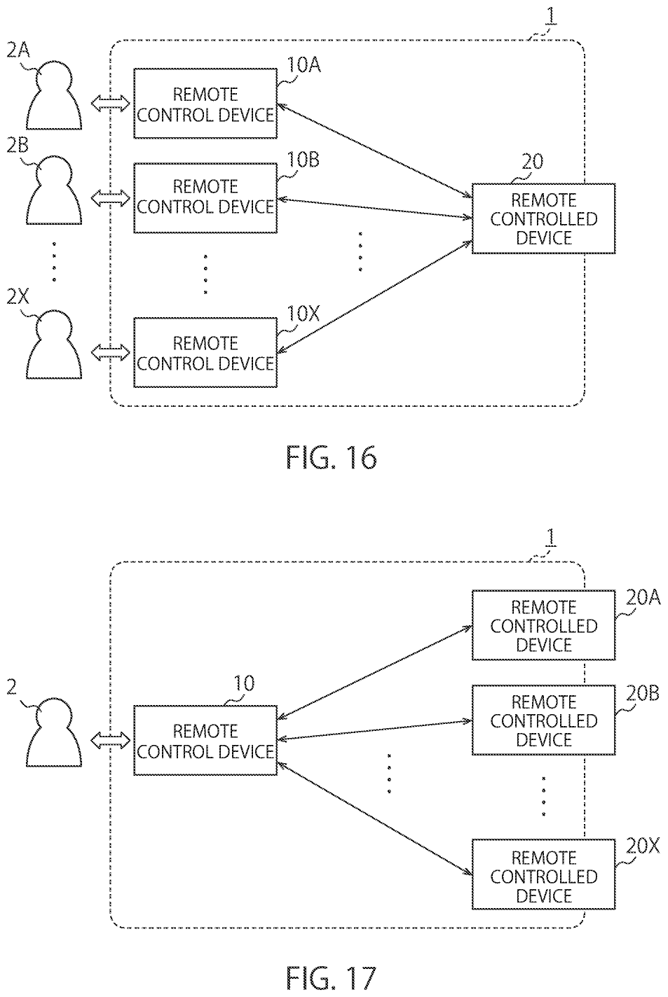

FIG. 16 is a diagram illustrating another implementation example of the remote control device and the remote controlled device in the remote control system 1. The remote control system 1 may include, for example, a plurality of remote control devices 10A, 10B, . . . 10X connectable to one remote controlled device 20. The remote control devices 10A, 10B, . . . 10X are operated by manipulators 2A, 2B, . . . 2X, respectively.

The remote controlled device 20 transmits, for example, the divided task or event to the remote control device controlled by the manipulator who can appropriately process it. For example, it is also possible to make a notification to issue a command so as to prevent the processing from being concentrated on one remote control device 10. This makes it possible to prevent the load from concentrating on one manipulator.

Besides, in the case where there are operations in which some manipulators are strong or weak, it is also possible to transmit the divided task to the remote control device 10 for the manipulator 2 who is strong in processing the divided task. This makes it possible to increase the accuracy of the execution of the task and increase the accuracy of the training by the trainer 216.

FIG. 17 is a diagram illustrating another implementation example of the remote control device and the remote controlled device in the remote control system 1. The remote control system 1 may include, for example, a plurality of remote controlled devices 20A, 20B, . . . 20X to be connectable to one remote control device 10.

118 Each of the remote controlled devices 20 transmits the divided task or event to the one remote control device 10. For example, when the task executed by each of the remote controlled devices 20 is light, a command of an indirect instruction or a direct instruction may be transmitted so that the tasks of the plurality of remote controlled devices 20A, 20B, . . . 20X can be executed by one manipulator 2.

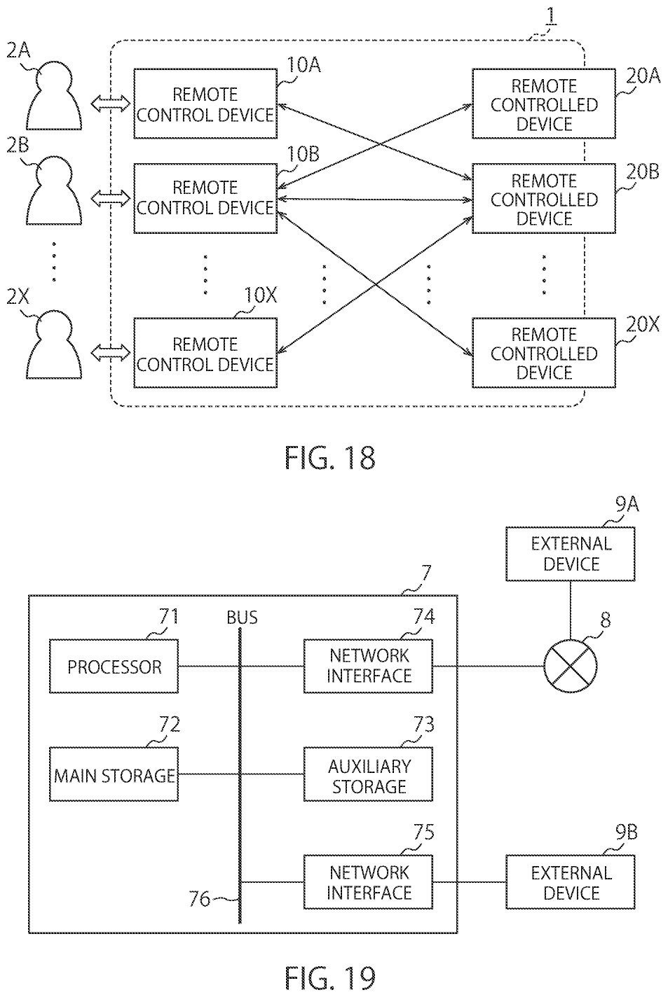

FIG. 18 is a diagram illustrating another implementation example of the remote control device and the remote controlled device in the remote control system 1. The remote control system 1 may include a plurality of remote control devices 10A, 10B, . . . 10X and a plurality of remote controlled devices 20A, 20B, . . . 20X connectable to them.

The implementation as above makes it possible that the plurality of remote controlled devices 20 notify the manipulator having a divided task or event that the manipulator is strong in or can process to appropriately issue an instruction for the divided task or event. In this case, the remote control devices 10 and the remote controlled devices 20 do not need to be connected in a one-to-one manner and, for example, a switch or a communication controller that determines which of the remote control devices 10 is to be connected to which of the remote controlled devices 20 may be provided in the remote control system 1.

For example when the divided task or the like is transmitted to the remote control device 10 side, the remote control system 1 according to this embodiment may transmit a signal for confirming the vacant state to the remote control device 10 in advance, receive an ACK signal for the signal, and then transmit the divided task.

As another example, when transmitting the divided task and receiving a NACK signal for the divided task from the remote control device 10, the remote controlled device 20 may transmit again the divided task to another remote control device 10.

The remote controlled device 20 may broadcast the divided task or the like or simultaneously transmit it to some or all of the connected remote control devices 10, or the manipulator who can cope with it in the remote control device 10 which has received the divided task or the like may secure it and issue an instruction.

The manipulator may register the processing in which the manipulator is strong or the processing with which the manipulator can cope, in advance in the remote control device 10. The remote controlled device 20 may confirm the registered information before or after the execution of the task, and transmit the divided task to an appropriate remote control device 10.

In the case where a plurality of remote controlled devices 20 are provided and the training is being executed in each of the remote controlled devices 20, their trained models may be combined by an appropriate method. Further, a storage may be provided in the remote control system 1 and outside the plurality of remote controlled devices 20, and the information on the divided task or the indirect instruction may be stored in the storage. In this case, the storage may store the information only on one of the plurality of remote controlled devices 20, may store the information on a plurality of remote controlled devices 20 in the remote control system 1, or may store the information on all of remote controlled devices 20 in the remote control system 1.

Further, based on the above information, the training of the model may be performed outside the remote controlled device 20.

Note that the model subjected to the training may be a trained model provided in the remote controlled device 20 in the remote control system 1, may be a trained model provided outside the remote control system 1, or may be a not-trained model.

The transmission and reception or the like of the above data is indicated as an example, but not limited to this, and may have any configuration as long as the remote control device 10 and the remote controlled device 20 are appropriately connected.

As explained above, the remote control system 1 may include appropriate numbers of remote control devices 10 and remote controlled devices 20, in which case more suitable processing can be more smoothly performed.

Note that in each of the above embodiments, the remote control is mentioned but may be read as a remote manipulation. As explained above, in this disclosure, the system may be the one which directly performs remote control or may be the one which controls a device for performing remote control.

The trained models of above embodiments may be, for example, a concept that includes a model that has been trained as described and then distilled by a general method.

Some or all of each device (the remote control device 10 or the remote controlled device 20) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

FIG. 19 is a block diagram illustrating an example of a hardware configuration of each device (the remote control device 10 or the remote controlled device 20) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 19 is provided with each component one by one but may be provided with a plurality of the same components. Although one computer 7 is illustrated in FIG. 19, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (the remote control device 10 or the remote controlled device 20) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (the remote control device 10 or the remote controlled device 20) in the above embodiments may be executed in parallel processing using one or more processors or using a plurality of computers over a network. The various arithmetic operations may be allocated to a plurality of arithmetic cores in the processor and executed in parallel processing.

Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuity, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (the remote control device 10 or the remote controlled device 20) in the above embodiments may be enabled by one or more processors 71. The processor 71 may refer to one or more electronic circuits located on one chip, or one or more electronic circuitries arranged on two or more chips or devices. In the case of a plurality of electronic circuitries are used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (the remote control device 10 or the remote controlled device 20) in the above embodiments may be enabled by the main storage device 72 or the auxiliary storage device 73 or may be implemented by a built-in memory built into the processor 71. For example, the storages 102, 202 in the above embodiments may be implemented in the main storage device 72 or the auxiliary storage device 73.

In the case of each device (the remote control device 10 or the remote controlled device 20) in the above embodiments is configured by at least one storage device (memory) and at least one of a plurality of processors connected/coupled to/with this at least one storage device, at least one of the plurality of processors may be connected to a single storage device. Or at least one of the plurality of storages may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (the remote control device 10 or the remote controlled device 20) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,”“based on data,”“according to data,”“in accordance with data” (including similar expressions), unless otherwise specified, this may include cases where the result is obtained based only on the data, and may also include cases where the result is obtained by being affected factors, conditions, and / or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrically connection/coupling,” “communicatively connection/coupling,”“operatively connection/coupling,”“physically connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. A remote controlled device, comprising:
one or more memories; and
one or more processors, wherein the one or more processors are configured to, when an event relating to a task being executed by a remote control object occurs:
transmit information on a subtask of the task;
receive a command relating to the subtask; and
execute the task based on the command.

2. The remote controlled device according to claim 1, wherein:
the subtask relates to a recognition processing of an object or an environment; and
the command received when the event occurs includes information for correcting a result of the recognition processing of the subtask.

3. The remote controlled device according to claim 2, wherein the task includes another subtask of operating the remote control object based on the result of the recognition processing of the subtask.

4. The remote controlled device according to claim 2, the event relating to the task is an event that an accuracy or a reliability of the recognition processing is low.

5. The remote controlled device according to claim 1, wherein the event relating to the task is an event that makes the task fail or difficult.

6. The remote controlled device according to claim 1, wherein the task relates to an autonomous moving, and the subtask relates to an environment recognition.

7. The remote controlled device according to claim 1, wherein the task relates to an autonomous moving, and the subtask relates to at least one of a movable range recognition or a moving route generation.

8. The remote controlled device according to claim 1, wherein
the one or more processors are configured to, when the event relating to the task being executed by the remote control object occurs, suspend the execution of the subtask corresponding to the event, receive the command, and then resume the execution of the suspended task based on the received command.

9. The remote controlled device according to claim 1, wherein
the command includes an indirect instruction including information necessary for generation of an operation of executing the task.

10. The remote controlled device according to claim 9, wherein
the indirect instruction includes information relating to at least one of recognition of an object, decision of a grip position, a result with low reliability, a moving route, or a movable range of the remote controlled device.

11. The remote controlled device according to claim 1, wherein
the command includes a direct instruction of directly instructing an operation of the remote control object.

12. The remote controlled device according to claim 9, wherein
the one or more processors are configured to, when an event occurs:
analyze the task based on the event;
generate the subtask based on the analysis; and
execute the transmission.

13. The remote controlled device according to claim 12, wherein
the one or more processors are configured to transmit information on the subtask or the event from the remote control object to a remote control device.

14. The remote controlled device according to claim 13, wherein
the one or more processors are configured to further accept, from the remote control device, the command for executing at least part of the task for the output subtask or event.

15. The remote controlled device according to claim 12, wherein
the one or more processors are configured to detect the event based on information acquired by one or more sensors.

16. The remote controlled device according to any one of claim 12, further comprising
a trained model used for the task, wherein
the one or more processors are configured to:
store information on the indirect instruction and the subtask in the one or more memories; and
train the trained model based on the information relating to the subtask stored in the one or more memories.

17. The remote controlled device according to claim 16, wherein
the one or more processors are configured to perform reinforcement learning using the subtask and the indirect instruction as teacher data.

18. The remote controlled device according to claim 16, wherein
the one or more processors are configured to autonomously control the remote control object so as to be capable of executing the task based on a result of the training.

19. The remote controlled device according to claim 1, wherein the remote controlled device includes the remote control object.

20. A remote control system comprising:
a remote controlled device including a remote control object configure to execute a task; and
a remote control device configured to remotely control the remote control object, wherein:
the remote controlled device transmits a subtask of the task to be executed to the remote control device; and
the remote control device transmits a command for the subtask to the remote controlled device based on the subtask received from the remote controlled device.

21. The remote control system according to claim 20, wherein the task executed by the remote control object includes a recognition subtask of recognizing objects, the subtask transmitted from the remote controlled device to the remote control device relates to at least the recognition subtask, and the command transmitted from the remote control device to the remote controlled device includes information to assist the recognition subtask executed by the remote control object.

22. The remote control system according to claim 20, wherein
the remote control device transmits, as the command, at least one of a direct instruction for directly instructing an operation of the remote controlled device, or an indirect instruction which is not a direct operation of the remote controlled device but is an indirect instruction including information necessary for executing the subtask, to the remote controlled device.

23. The remote control system according to claim 21, further comprising
a storage configured to store information on the direct instruction or the indirect instruction.

24. The remote control system according to claim 22, further comprising
a trained model configured to execute the task, wherein
training for solving an event relating to the subtask is executed on the trained model based on the indirect instruction for the subtask.

25. The remote control system according to claim 20, further comprising
first and second remote controlled devices, wherein
the remote control device is configured to:
remotely control the remote control object included in each of the first and second remote controlled devices; and
transmit a command for each of subtasks to the corresponding remote controlled device based on each of the subtasks received from each of the remote controlled devices.

26. A remote control device comprising:
one or more memories; and
one or more processors, wherein
the one or more processors are configured to, when an event of a task occurs:
receive a subtask of the task from a remote control object; and
transmit a command relating to the subtask to the remote control object, and cause the remote control object to execute the subtask based on the command.
